(19) United States
(12) Patent Application Publication
(10) Pub. No.: US 2009/0298420 A1
(43) Pub. Date: Dec. 3, 2009

(54) APPARATUS AND METHODS FOR TIME SYNCHRONIZATION OF WIRELESS AUDIO DATA STREAMS

(75) Inventors: Jacobus Cornelis Haartsen, Hardenberg (NL); Roelof Mink, Emmen (NL)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 12/169,848

(22) Filed: Jul. 9, 2008

Related U.S. Application Data
(60) Provisional application No. 61/056,129, filed on May 27, 2008.

(51) Int. Cl. H04H 40/00

(52) U.S. Cl. 455/3.06

(57) ABSTRACT

A wireless audio data distribution system streams audio data from an audio source device to a plurality of speaker devices across a wireless communication network. The speaker devices synchronize the start of their decoding of received audio data and compensate for relative skew over time of internal clocks in response to occurrence of timing events that are defined relative to signaling from the wireless communication network.

### CROSS REFERENCE TO RELATED APPLICATION

The present application claims the benefit of and priority to U.S. Provisional Patent Application No. 61/056,129, filed May 27, 2008, entitled “APPARATUS AND METHODS FOR TIME SYNCHRONIZATION OF WIRELESS AUDIO DATA STREAMS.” the disclosure of which is hereby incorporated herein by reference in its entirety.

### FIELD OF THE INVENTION

The present invention relates to electronic audio devices and, more particularly, to streaming audio signals to remote speakers through a wireless interface.

### BACKGROUND OF THE INVENTION

It is becoming increasingly more commonplace for electronic devices to provide wireless distribution of audio signals as improved compression techniques are becoming available that allow lower communication rates and longer playing time and as power efficiencies improve to allow increased playtime from batteries.

For example, headsets are available that can receive wireless streaming stereo audio from wireless phones, digital audio music players, and other audio source devices. Separate audio data for the left and right stereo channels can be separately transmitted by an audio source device through different repetitive frames of the wireless air interface to a headset. In the headset, the audio data is decoded and provided to the speakers through associated amplifiers and cabling.

### SUMMARY OF THE INVENTION

Various embodiments of the present invention are directed to a wireless audio data distribution system that streams audio data from an audio source device to a plurality of speaker devices across a wireless communication network. The speaker devices synchronize the start of their decoding of received audio data and compensate for relative skew over time of internal clocks in response to occurrence of timing events that are defined relative to signaling from the wireless communication network.

In some embodiments, a method of operating a wireless audio system includes establishing a wireless communication network between an audio source device and a plurality of speaker devices. A common network clock is established that is used by the audio source device and the plurality of speaker devices and which is timed relative to defined repetitively occurring signals of the wireless communication network. A command is received from the audio source device at each of the speaker devices via the wireless communication network that defines a timing event relative to the common network clock when each of the speaker devices is to initiate sound generation from a packet of audio data received from the audio source device. Within each of the speaker devices, sound generation is initiated from a packet of audio data previously received from the audio source device in response to occurrence of the timing event.

In some further embodiments, the command is broadcasted from the audio source device for receipt by all of the speaker devices. After broadcasting the command, packets of audio data can then be sequentially transmitted to different ones of the speaker devices through corresponding different sequential communication frames of the wireless communication network configured as a time division multiple access (TDMA) network. The command can define a number of sequentially occurring frames that the speaker devices are to delay after the frame that transported the command before the speaker devices initiate generation of sound from their respective packets of audio data previously received from the audio source device.

In some further embodiments, the packets of audio data are transmitted from the audio source device to different ones of the speaker devices through corresponding different sequential communication frames of a time divisional multiple access (TDMA) network. Cycles of the common network clock are generated within the speaker devices relative to timing of receipt of defined signaling for the frames of the TDMA network. Each of the speaker devices initiates the sound generation in response to occurrence of a timing event defined by the command relative to cycles of the common network clock.

Each of the speaker devices can carry out audio decoding of the packet of audio data, which was previously received from the audio source device, in response to occurrence of the timing event defined by the command relative to the defined signaling for the frames of the TDMA network.

The packets of audio data can be transmitted from the audio source device to different ones of the speaker devices through corresponding different sequential communication frames of a Bluetooth network. Cycles of the common network clock can be generated within the speaker devices relative to timing of receipt of frame access codes of the Bluetooth network. Each of the speaker devices can initiate the sound generation in response to receipt of a particular one of the frame access codes that is defined by the command received from the audio source device.

Each of the speaker devices can carry out audio decoding of the packet of audio data, which was previously received from the audio source device, in response to receipt of a frame access code that indicates occurrence of a particular frame that is defined by the command received from the audio source device.

The packets of audio data can be transmitted from the audio source device to different ones of the speaker devices through corresponding different sequential communication frames of a Bluetooth network. Cycles of the common network clock can be generated within the speaker devices relative to timing of receipt of header start signaling, header-error correction code for data payload, and/or cyclic redundancy code for data payload within frames of the Bluetooth network. Each of the speaker devices can initiate the sound generation in response to a defined time delay after occurrence of a particular cycle of the common network clock, the defined time delay and the particular cycle being defined by the command received from the audio source device.

A sequence of correlation output values can be generated that each indicate an amount of correlation between a portion of a sequence of data bits received from the TDMA network and a defined pattern of data bits. Each of the speaker devices can initiate the sound generation in response to a determining timing of occurrence of a maximum correlation output value within a frame of the TDMA network.

In some further embodiments, within each of the speaker devices, an adjusted clock signal can be generated that is time offset a controllable amount relative to a local clock signal generated by a local clock circuit, wherein the time offset is controlled in response to phase differences between the local clock signal and timing of the defined repetitively occurring signals of the wireless communication network.

Generation of sound from each of the speaker devices can include decoding the packed of audio data responsive to generate PCM data that is buffered in a PCM data buffer, initiating output of the buffered PCM data from the PCM data buffer through a digital-to-analog converter to a speaker in response to the occurrence of the timing event, and clocking the output of the PCM data from the PCM data buffer responsive to cycles of the adjusted clock signal.

Generation of sound from each of the speaker devices can alternatively or additionally include operating an audio decoder to decode the packet of audio data responsive to cycles of the adjusted clock signal.

The timing of hopping through a defined sequence of frequencies at which the speaker devices communicate with the audio source device can be synchronized in response to cycles of the adjusted clock signal.

The packets of audio data can be transmitted from the audio source device to different ones of the speaker devices through corresponding different sequential communication frames of a time divisional multiple access (TDMA) network. Within each of the speaker devices, the amount of time offset of the adjusted clock signal is controlled in response to timing of receipt of defined signaling for the frames of the TDMA network. The audio decoder within each of the speaker devices is operated responsive to cycles of the adjusted clock signal.

The packets of audio data can be transmitted from the audio source device to different ones of the speaker devices through corresponding different sequential communication frames of a Bluetooth network. Within each of the speaker devices, the amount of time offset of the adjusted clock signal is controlled in response to timing of receipt of frame access codes of the Bluetooth network.

The packets of audio data can be transmitted from the audio source device to different ones of the speaker devices through corresponding different sequential communication frames of a Bluetooth network. Within each of the speaker devices, the amount of time offset of the adjusted clock signal is controlled in response to timing of receipt of header start signaling, header-error correction code data payload, and/or cyclic redundancy code for data payload within frames of the Bluetooth network.

The packets of audio data can be transmitted from the audio source device to different ones of the speaker devices through corresponding different sequential communication frames of a Bluetooth network. The local clock circuit comprises a low power oscillator clock that is used to maintain periodic synchronization of a Bluetooth transceiver in each of speaker devices and the Bluetooth network when operating in a power-savings Bluetooth Sniff mode. The adjusted clock signal is time offset a controllable amount relative to the low power oscillator in response to phase differences between a signal from the low power oscillator and timing of the defined repetitively occurring signaling of frames of the Bluetooth network.

A sequence of correlation output values can be generated that each indicate an amount of correlation between a portion of a sequence of data bits received from the TDMA network and a defined pattern of data bits. Each of the speaker devices controls the time offset of the adjusted clock signal in response to a determined timing of occurrence of a maximum correlation output value within a frame of the TDMA network.

Some other embodiments of the present invention are directed to a wireless speaker device that includes a wireless transceiver, an audio data buffer, a start audio decoding event detector, a decoder circuit, and a speaker circuit. The wireless transceiver is configured to establish a time division multiple access (TDMA) network with an audio source device, to receive from the audio source device packets of audio data in defined ones of sequentially occurring communication frames of the TDMA network, and to receive a command from the audio source device. The start audio decoding event detector is configured to determine from the received command a timing event, which is defined relative to repetitively occurring signaling for the frames of the TDMA network, when the start audio decoding event detector is to generate an audio start signal to initiate audio decoding, and to generate the audio start signal in response to occurrence of the timing event. The decoder circuit is configured to temporarily store a received packet of audio data in the audio data buffer awaiting audio decoding, and to carry out decoding of the packet of buffered audio data in response to the audio start signal. The speaker circuit is configured to generate sound in response to the decoded audio packet from the decoder circuit.

Some other embodiments of the present invention are directed to a wireless audio source device that includes a wireless transceiver and a controller. The wireless transceiver is configured to establish a time division multiple access (TDMA) network with a plurality of speaker devices. The controller is configured to sequentially transmit packets of audio data to different ones of the speaker devices through corresponding different sequentially occurring communication frames of the TDMA network, and to broadcast a command to the speaker devices that defines a timing event relative to repetitively occurring signaling for the frames of the TDMA network when each of the speaker devices is to initiate audio decoding and sound generation from a packet of audio data received from the audio source device.

### BRIEF DESCRIPTION OF THE DRAWINGS

The accompanying drawings, which are included to provide a further understanding of the invention and are incorporated in and constitute a part of this application, illustrate certain embodiments of the invention. In the drawings:

FIG. 1 is a diagram of a wireless audio distribution system that is configured to operate in accordance with some embodiments of the present invention;

FIG. 2 is a diagram of a Bluetooth piconet audio distribution system that includes a phone, which is configured as a master, and stereo speakers, which are configured as slaves, that receive streaming stereo music from the phone in accordance with some embodiments of the present invention;

FIG. 3 is a block diagram of a conventional Bluetooth speaker device, such as a Bluetooth headset;

FIG. 4 is a block diagram of receiver circuitry of a Bluetooth speaker device in accordance with some embodiments of the present invention;

FIG. 5 is a further block diagram of a Bluetooth speaker device in accordance with some embodiments of the present invention;

FIG. 6 is a timing diagram that illustrates operations and methods that can be carried out by a plurality of Bluetooth master and slave speaker devices to synchronize the start of audio decoding and to compensate for timing skew, which can accumulate over time, in response to occurrence of defined timing events in the Bluetooth piconet in accordance with some embodiments of the present invention;

FIG. 7 is a flowchart and data flow diagram showing exemplary operations and methods of the audio source device and an exemplary one of the speaker devices of FIG. 1 in accordance with some embodiments of the invention; and

FIG. 8 is a block diagram of exemplary components of a wireless audio distribution system that includes a master communication terminal, a slave wireless headset, and a pair of wireless speakers which are configured in accordance with some embodiments of the present invention.

### DETAILED DESCRIPTION OF EMBODIMENTS OF THE INVENTION

Various embodiments of the present invention will now be described more fully hereinafter with reference to the accompanying drawings. However, this invention should not be construed as limited to the embodiments set forth herein. Rather, these embodiments are provided so that this disclosure will be thorough and complete, and will convey the scope of the invention to those skilled in the art.

It will be understood that, as used herein, the term “comprising” or “comprises” is open-ended, and includes one or more stated elements, steps and/or functions without precluding one or more unstated elements, steps and/or functions. As used herein, the singular forms “a”, “an” and “the” are intended to include the plural forms as well, unless the context clearly indicates otherwise. The term “and/or” and “/” includes any and all combinations of one or more of the associated listed items. In the drawings, the size and relative sizes of regions may be exaggerated for clarity. Like numbers refer to like elements throughout.

Some embodiments may be embodied in hardware and/or in software (including firmware, resident software, micro-code, etc.). Consequently, as used herein, the term “signal” may take the form of a continuous waveform and/or discrete value(s), such as digital value(s) in a memory or register. Furthermore, various embodiments may take the form of a computer program product on a computer-usable or computer-readable storage medium having computer-usable or computer-readable program code embodied in the medium for use by or in connection with an instruction execution system. Accordingly, as used herein, the terms “circuit” and “controller” may take the form of digital circuitry, such as computer-readable program code executed by an instruction processing device(s) (e.g., general purpose microprocessor and/or digital signal microprocessor), and/or analog circuitry. The operations that are described below with regard to the figures can therefore be at least partially implemented as computer-readable program code executed by a computer (e.g., microprocessor).

Embodiments are described below with reference to block diagrams and operational flow charts. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

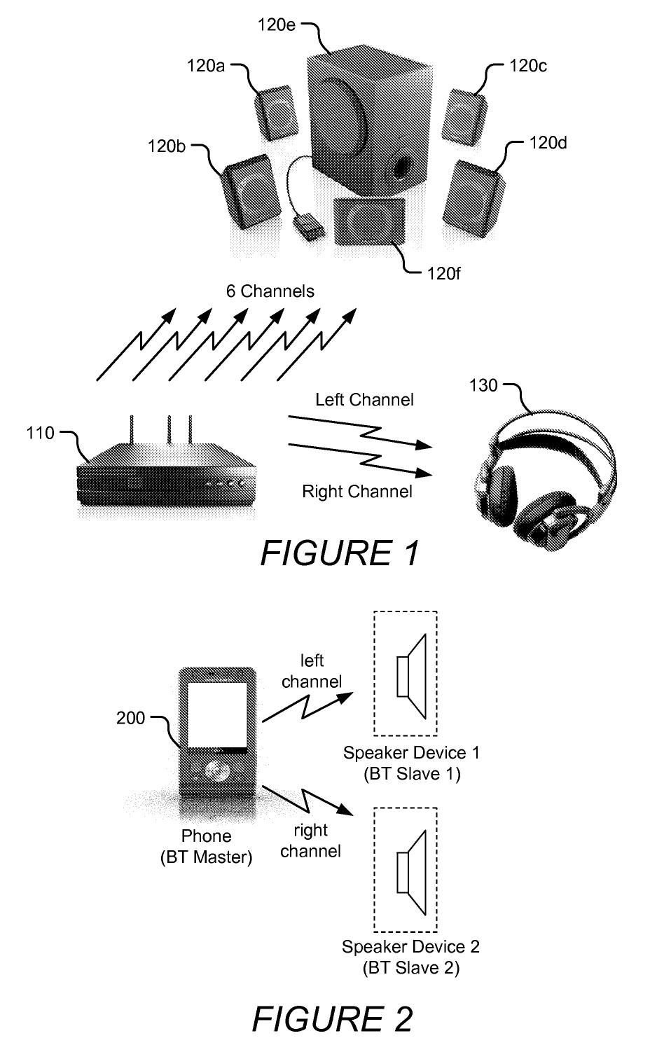

FIG. 1 is a diagram of a wireless audio data distribution system that is configured to operate in accordance with some embodiments of the present invention. Referring to FIG. 1, the system can include an audio source device 110 (e.g., a digital audio player) that streams audio data to a plurality of speaker devices across a wireless communication network. In the exemplary embodiment, the audio source device 110 can send stereo audio signals through a separate left communication channel to the left speaker of the wireless headset 130 and through a right communication channel to the right speaker of the headset 130. The left and right communication channels can correspond to different repeating slots within a time division multiple access (TDMA) wireless communication interface, such as that provided by a Bluetooth communication piconet and/or by a wireless local area network (WLAN).

The audio source device 110 may alternatively or additionally send audio signals through six separate channels, which again can correspond to six or more different repeating time slots within a Bluetooth piconet and/or WLAN, to six different wireless speaker devices 120a-e. The wireless speaker devices 120a-e may be spaced apart within a room to provide surround sound and can be configured, for example, to provide a front-left audio channel from device 120a, rear-left audio channel from device 120b, a front-right channel from device 120c, a rear-right audio channel from device 120d, a center channel 120e, and a sub-woofer channel from device 120e.

Each of the speaker devices (e.g., devices 130 and 120a-f) can include a wireless digital communication radio circuit (e.g., Bluetooth/WLAN radio), audio decoder circuit, a digital-to-analog converter (DAC) circuit, amplifier circuit, power source circuit, speaker device, and other electronics.

Because the audio signals are streamed to a plurality of physically separated speaker devices, it can be important to control the timing of when corresponding audio signals are generated from each of the speaker devices so that the sound will reach a person with an intended stereo/surround sound effect. For example, a person can be provided with the perception of spatial depth and directionality for sound by accurately controlling the relative timing phase between corresponding sounds that are generated from each of the speaker devices. Controlling time synchronization between the separate speakers within tight constraints can therefore be important to providing high-quality audio from, for example, stereo and surround-sound speaker systems.

For a stereo headset, the Applicants hereof have determined that the distance between a person and the spaced apart speakers can affect the amount of time delay that can exist between arrival of corresponding sounds from the speakers before the person perceives an undesirable level of time delay (e.g., noise) therefrom. For example, when audio receivers are configured to sample audio at a nominal rate of 44.1 kHz and the time delay (phase shift) between corresponding arriving sound of the right and left channel is greater than about 5 audio samples (e.g., at 44.1 ksamples/s this delay corresponds to about 100 μs) a person may perceive an undesirable time delay (e.g., noise) between the audio signals received from the right and left headset speakers. For speakers that are positioned within a room, the Applicants hereof have determined that the time delay (phase shift) is more relaxed and can be up to about 150 audio samples (corresponding to a 3 ms time difference) before a person may perceive an undesirable time delay (e.g., noise) between the incoming audio signals.

A person's hearing may be even more sensitive to rapid variation over time in the timing offsets due to, for example, jitter in the relative delay between the corresponding sounds from the speakers. Thus, for example, there may be an even greater need to avoid undesirable jitter (e.g., rapid change over time) in the relative timing between the corresponding sounds.

Therefore, it can be important to control when each of the spaced apart speaker devices begins producing sound that is generated from decoding audio data that is received through a streaming wireless channel, and it can be further important to control drifting between local clocks that are used within each of the speaker devices to control audio processing and/or other sound generation operations and which can undesirably accumulate relative time skew over time. To constrain the time delay (phase shift) between the right and left channel that is heard by a person to no more than 5 audio samples, the left and right speaker devices should be synchronized to begin outputting their respective audio signals (e.g., left and right components of the stereo signal) within 100 μs of each other and should be repetitively adjusted to maintain relative synchronization of their respective audio signals to less than that timing error.

Although various embodiments are described herein in the context of audio data that is streamed through a Bluetooth piconet, the invention is not limited thereto. In some further embodiments, audio data may be streamed from a digital audio player to speaker devices through any wireless air interface, including, but not limited to, a WLAN interface and/or one or more cellular communication interfaces.

FIG. 2 is a diagram of a Bluetooth (BT) piconet audio data distribution system that includes a cellular phone 200 which is configured as a master audio source device and two stereo speaker devices BT Slave 1 and BT Slave 2 (e.g., within the headset 130 in FIG. 1) which are configured as slaves that receive streaming stereo music from the phone 200 in accordance with some embodiments of the present invention. Although only two speaker devices BT Slave 1 and BT Slave 2 are shown in FIG. 2 for ease of explanation, the invention is not limited thereto, and may include any plural number of speaker devices, such as the six wireless surround-sound speaker devices 120a-f shown in FIG. 1.

With continued reference to FIG. 2, we begin with a description of operations and methods that compensate for time drift that can occur between the left speaker device BT Slave 1 and the right speaker device BT Slave 2. The left and right speaker devices BT Slave 1 and BT Slave 2 receive streaming audio from the phone 200 through a Bluetooth piconet.

The phone 200 serially transmits left component audio data to the left speaker BT Slave 1 device within defined communication slots (e.g., certain odd numbered slots) of the Bluetooth piconet and transmits right component audio data to the right speaker device BT Slave 2 within different defined communication slots (e.g., certain even numbered slots) of the Bluetooth piconet. Accordingly, the phone 200 can repetitively and alternately transmit a packet of left component audio data to the left speaker device BT Slave 1 and then a packet of right component audio data to the right speaker device BT Slave 2 in different ones of the periodic communication slots. Accordingly, the audio data that is received by the left and right speaker devices BT Slave 1 and BT Slave 2 is offset in time from one another because the left and right audio data components are sequentially transmitted through serialized time slots.

Accordingly, if the left and right speaker devices BT Slave 1 and BT Slave 2 were each configured to respond to receipt of their respective packets of audio data by immediately decoding and broadcasting audio from their respective speakers, the timing offset that occurs between receipt of corresponding packets of audio data by the left speaker device BT Slave 1 and then the right speaker device BT Slave 2 would result in a time delay (phase delay) of at least one communication slot time between the sound that is output by their speakers. Such undesirable time delay in the speaker output would increase as the number of time slots that are used to transmit the packets of audio data increases and/or as the number of speaker devices to which the audio data is serially transmitted increases.

Alternatively, the audio data for the left and right speakers of the headset 130 may be transmitted in a shared packet to the headset 130, where the left and right component audio data can then be separated and provided to the corresponding left and right speakers.

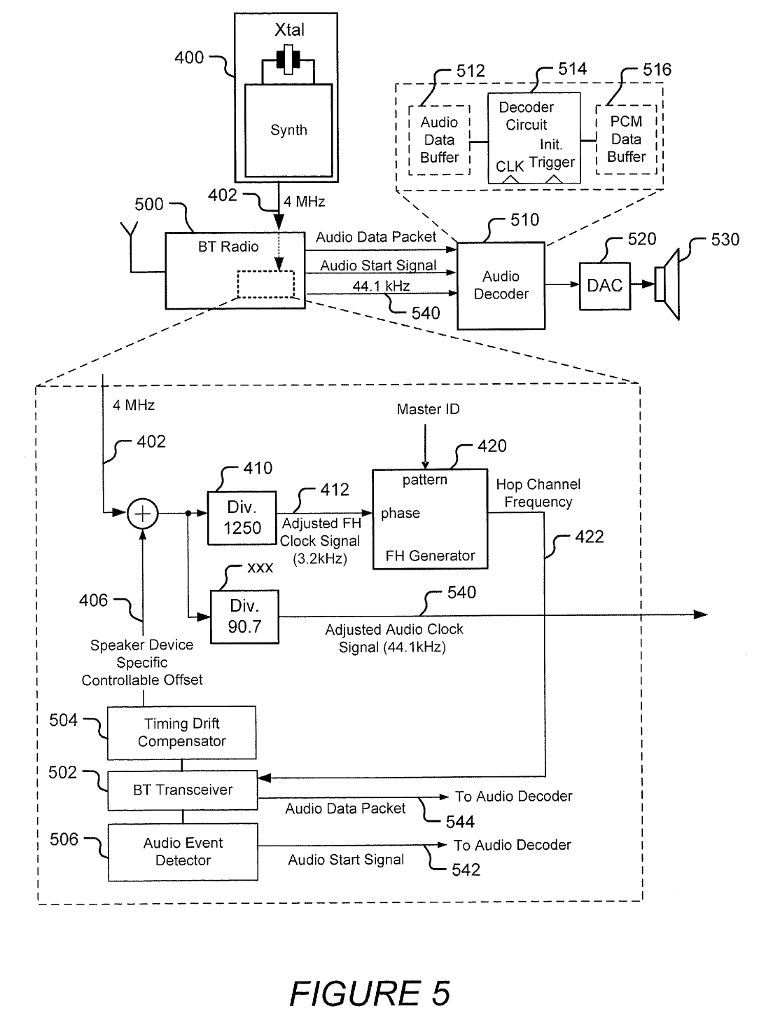

The left and right component audio data may be processed by their respective audio decoders at different points in times. The delay difference may be the result of different arrival times of the left and right component audio data on the wireless link. Alternatively or additionally, the delay differences may be the result of the audio decoders being implemented in host processors that multitask such audio processing with other tasks, and which may therefore process the left and right component audio data at different times. Therefore, the exact timing of the audio decoding may differ between the speaker devices. Thus, it can be important to at least synchronize the timing of when PCM samples generated by decoding the audio data components are provided to a digital-to-analog converters (DAC) and connected speakers so that the resulting sound generated from the speakers is synchronized to one another in time. Therefore, as will be described below with regard to FIG. 5, in some embodiments the initiation of decoding of audio data is synchronized between the speaker devices, and in some other embodiments the PCM samples generated by the audio decoding are buffered and then clocked out of the buffer in a synchronous manner.

Referring again to FIG. 1, in a similar manner, the time delay between when the first of six speakers 120a receives audio data from the audio source device 110 and when the last of six speakers 120f receives audio data from the audio source device 110 may correspond to the timing of at least six sequential timeslots of the Bluetooth piconet that are used to separately transmit the six different audio data components.

To synchronize the timing of the audio that is output from the speaker devices BT Slave 1, BT Slave 2, and/or 120a-f so as to compensate for the time offset caused by the alternating receipt of audio data through sequential communication frames and/or other time delay effects, a common network clock is established that is used by the audio source device and the plurality of speaker devices and which is timed relative to defined repetitively occurring signals of the Bluetooth piconet. A command is broadcast from the audio source device 110/phone 200, which can be received by each of the speaker devices BT Slave 1, BT Slave 2, and 120a-f via the Bluetooth piconet, that defines a timing event relative to the common network clock when each of the speaker devices is to initiate sound generation from a packet of audio data that has been or will be received from the audio source device 110/phone 200. Within each of the speaker devices BT Slave 1, BT Slave 2, and 120a-f, sound generation is initiated from a packet of audio data in response to occurrence of the defined timing event.

As will be explained below with regard to FIG. 4, the common network clock may be timed relative to signaling that is used by the speaker devices to, for example, maintain hop synchronicity with the source device 110/phone 200 through the Bluetooth piconet.

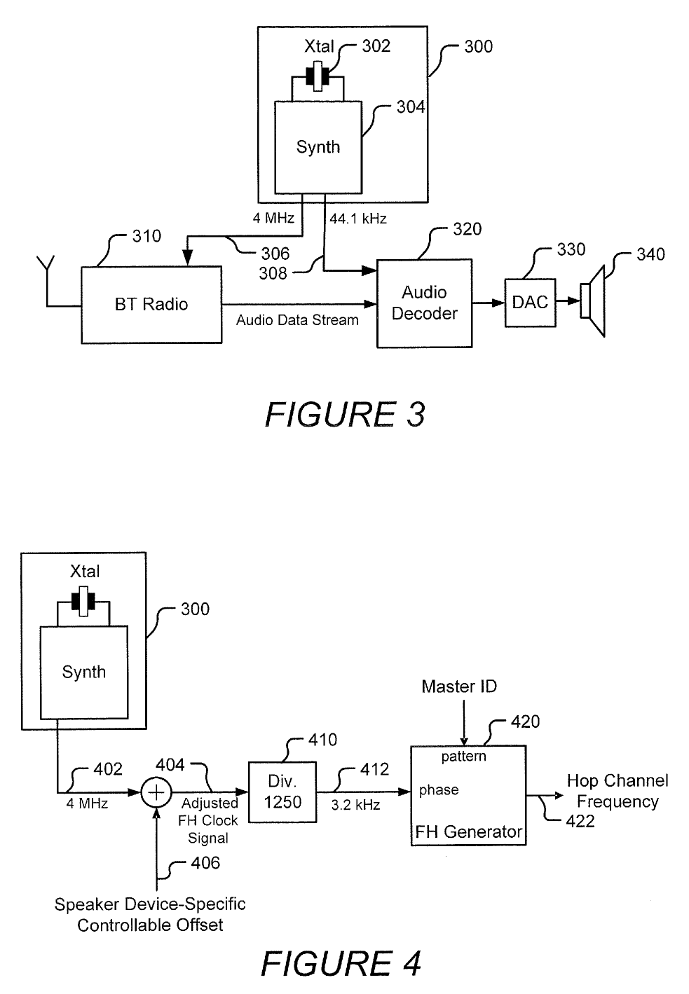

FIG. 3 is a block diagram of a portion of a conventional Bluetooth speaker device. A system clock 300 is used as a timing reference and includes a crystal oscillator device Xtal 302 that outputs a 13 MHz, 26 MHz, or another frequency clock signal, and a clock synthesizer 304 generates therefrom two clock signals 306 and 308. One of the clock signals 306 (e.g., a 4 MHz clock signal) controls operation (e.g. frequency synthesis and transmit/receive frequency-hop timing) of a Bluetooth radio 310. The other clock signal 308 (e.g., a 16 kHz, 32 kHz, 44.1 kHz, 48 kHz, or other frequency clock signal) controls operation of an audio decoder 320 to decode audio data that is received from an audio source device. The decoded data is converted to an analog signal by a digital-to-analog (DAC) converter 330 and is amplified and fed-through a speaker 340 to generate sound.

When the exemplary circuit of FIG. 3 is used in two or more speaker devices, the system clocks of each of the slave speaker devices would drift over time relative to one another and result in an accumulation of timing error (timing skew) between the operation of the respective audio decoders of the speaker devices and result in associated phase error between the audio signals that are generated therefrom. Such error can degrade the perceived quality of the sound that is output from the audio distribution system.

FIG. 4 is a block diagram of receiver circuitry of a Bluetooth speaker device in accordance with some embodiments of the present invention. Referring to FIG. 4, the receiver circuit includes a local clock device 400 that generates a local clock signal 402 (e.g., 4 MHz). A common network clock is established that is timed relative to defined repetitively occurring signals of the Bluetooth piconet. More particularly, an adjusted clock signal 404 is generated that is time offset 406 a controllable amount relative to the local clock signal 402. The time offset 406 is controlled in response to phase differences between the local clock signal 402 and timing of defined repetitively occurring signals of the Bluetooth piconet (i.e., the common network clock).

As can be appreciated, the common network clock and the local clock signal 402 can be free-running without timing adjustment, with only the offset 406 being periodically/repetitively adjusted to maintain the adjusted clock signal 404 phase aligned with the common network clock.

The adjusted clock signal 404 is down-converted by a frequency divider 410 (e.g., divided by 1250) to generate a lower frequency adjusted clock signal 412 (e.g., 3.2 kHz). A frequency hop generator 420 steps through a sequence of transmit/receive hop frequencies 422 of the Bluetooth piconet that are defined by a master ID pattern in response to phase cycles of the lower frequency adjusted clock signal 412.

The common network clock is thereby used to compensate for drift that occurs over time between the local clock device 400 (i.e., the crystal Xtal and the synthesizer) and local clock circuits of other associated speaker devices. The time offset 406 can be defined to align the adjusted clock signal 404 with signaling of the Bluetooth piconet. Such time alignment can be used to synchronize the timing of the audio output from a plurality of the slave speaker devices, and may be used to assist with maintaining frequency hop synchronicity between the audio source device 110 and a plurality of speaker devices (e.g., operating as master and slave devices on the Bluetooth piconet) and allowing the speaker devices to more accurately predict the arrival of audio data packets from the audio source device 110.

In some embodiments, the packets of audio data are transmitted from the audio source device 110 to different ones of the speaker devices through corresponding different sequential communication frames of the Bluetooth piconet. The value of the offset 406 can be controlled in response to timing of receipt of frame access codes, timing of receipt of header start signaling, header-error correction code data payload, and/or cyclic redundancy code for data payload within frames of the Bluetooth network.

The value of the offset 406 can be determined based on symbol timing (with help of the frame access codes) in response to the arrival of each communication packet from the audio source device 110 via the Bluetooth piconet. For example, a sequence of correlation output values can be generated that each indicate an amount of correlation between a portion of a sequence of data bits defining the frame access codes received from the Bluetooth piconet and a defined pattern of data bits. The value of the offset 406 can be determined based on phase difference between the local clock signal 402 and timing of occurrence of a maximum correlation output value within a frame of the Bluetooth piconet. The offset 406 may thereby be controlled to cause the adjusted clock signal 404 to be synchronized within at least 0.25 μs relative to the common network clock and, thereby, relative to other adjusted clock signals 404 of other speaker devices.

In this manner, a plurality of speaker devices can decode audio data and generate sound therefrom in a synchronized manner using the local adjusted clock signals, and may further use the local adjusted clock signals to step through a sequence of transmit/receive hop frequencies in a synchronized manner with each other and the audio source device 110.

FIG. 5 is a block diagram of a Bluetooth speaker device that is configured in accordance with some embodiments of the present invention. The illustrated circuitry of FIG. 5 may be included in each of a plurality of speaker devices that communicate with the audio source device 110 via a Bluetooth piconet.

Referring to FIG. 5, the illustrated speaker device includes a Bluetooth radio 500, an audio decoder 510, a DAC 520, and a speaker 530. The Bluetooth radio 500 operates responsive to cycles of the local clock signal 402 from the local clock device 400, and includes the receiver circuitry of FIG. 4. As will be explained below, the audio decoder 510 outputs decoded audio data through the DAC to the speaker 530 in response to a clock signal 540 that is adjusted by the offset 406 responsive to signaling of the Bluetooth piconet, and the frequency hop generator 420 steps through the sequence of transmit/receive hop frequencies (Master ID) in response to the clock signal 412 that is adjusted responsive to signaling of the Bluetooth piconet.

The speaker device determines and updates its own offset value 406 with respect to defined signaling of the Bluetooth piconet which functions as a common network clock. The adjusted audio clock signal 540 is generated by down-converting the local clock signal 402 (e.g., dividing by 90.7) which has been adjusted using the value of the offset 406 to generate a desired frequency (e.g. 44.1 kHz) that is used to cycle the clock input (CLK) of the audio decoder 514. The speaker device may thereby decode audio data and hop through transmit/receive frequencies in-sync (e.g. within 0.25 μs accuracy) with other speaker devices and the audio source device 110. By adjusting the local clock signal 402 of each of the speaker devices relative to the common network clock, the audio decoder 510 of each of the speaker devices can effectively operate in a synchronized manner relative to one another while compensating for timing drift occurring in the each of the local clock devices 400.

The Bluetooth radio 500 may include a Bluetooth transceiver 502, a timing drift compensator 504, and an audio event detector 506. The exemplary audio decoder 510 can include a decoder circuit 514 and may further include an audio data buffer 512 and/or a PCM data buffer 514 which respond to an adjusted audio clock signal 540 (e.g., 44.1 kHz) and to an audio start signal 542.

The transceiver 502 may be configured in a conventional manner to receive, via the Bluetooth piconet, and to convolutionally decode a packet of audio data from the audio source device 110 or another master device and provide the audio data packet 544 to the audio decoder 510. The audio decoder 510 may temporarily store the received audio data packet in the audio data buffer 512.

The audio event detector 506 is configured to respond to a broadcast command packet that is received through the Bluetooth piconet from the audio source device 110 and which defines a timing event relative to the common network clock (e.g., defined signaling of the Bluetooth piconet) when the audio decoder 510 is to initiate decoding of a packet of audio data buffered in the audio data buffer 512. The decoded audio data is converted to an analog signal by the DAC 520 and amplified and provided to the speaker 530 to generate sound. The audio event detector 506 monitors signaling of the Bluetooth piconet to identify occurrence of the signaling that corresponds to the defined timing event and, responsive thereto, generates an audio start signal 542.

In some embodiments, the decoder circuit 514 is triggered by the audio start signal 542 to initiate decoding of the audio data in the buffer 512 to output PCM data, with its decoding operations cycled by the adjusted clock signal 540.

In some other embodiments, the decoder circuit 514 can decode the audio data as it is received and/or responsive to some other event (e.g., during defined multi-tasking cycles) while it is buffered in the buffer 512 in order to generate PCM data that is buffered in the PCM data buffer 516. Output of the PCM data from the PCM data buffer 516 through the DAC 520 to the speaker 530 may be triggered by the audio start signal 542, and with the data being clocked out of the buffer 516 in response to the adjusted clock signal 540.

The timing event defined by the command packet may, for example, correspond to a defined delay time (e.g., number of local slave clock cycles) after occurrence of a reference signal in the Bluetooth piconet. The reference signal in the Bluetooth piconet may correspond to a frame access code, header start signaling, a Header-Error Code (HEC) of a packet header, and/or a Cyclic Redundancy Code (CRC) of a packet payload. The event detector can output an audio start signal that can trigger the audio decoder circuit to begin decoding a packet of the buffered audio data and outputting a digital audio signal to the DAC 520, and from which the analog audio signal can be amplified and output from the speaker 530.

Accordingly, the speaker devices may begin decoding the received audio data in response to occurrence of the timing event. Alternatively, the speaker devices may immediately begin decoding the audio data upon its receipt from an audio source device, and may then await occurrence of the timing event before outputting the decoded data as, for example, pulse-code modulated (PCM) data through a codec, a DAC, and a speaker.

Using such signaling from the Bluetooth piconet, the time of arrival of an audio data packet may be determined with an accuracy of 0.25 μs or better. As described above, the arrival of an audio data packet may be accurately determined using a correlation unit (e.g., within the transceiver 502) that is matched to the bit sequence of the access code of each frame of the Bluetooth piconet. The correlator can oversample the received signals by a factor 4 or 8. Because the Bluetooth symbol time can be 1 us, such oversamping may enable the symbol timing to be determined with an accuracy of 0.25 μs (for an oversample factor of 4) or 0.125 μs (for an oversample factor of 8). The timing drift compensator 504 controls the value of the offset 406 in response to a phase difference between the local clock signal 402 and the time of occurrence of the maximum correlator output value, and/or it may control the offset 406 in response to the phase difference between the local clock signal 402 and other defined signaling of the Bluetooth piconet. The time of occurrence of the maximum correlator output value may also be used to define the best bit sampling time for a received signal. Interpolation may be carried out among the correlator output values to increase the accuracy of the detected time of occurrence of the maximum correlator output value.

The audio event detector 506 may, for example, initiate decoding of the audio data buffered in buffer 512 and/or initiate output of the decoded data from the PCM data buffer 516 at a defined time delay (e.g., defined number of cycles of the adjusted audio clock signal 540) after occurrence of the correlator maximum value.

Accordingly, with reference to FIG. 1, the audio source device 110 can command each of the speaker devices 120a-f to begin generation of sound from a packet of audio data (e.g., initiate decoding/initiate output of decoded data) that it will transmit or has already transmitted relative to a start time that is synchronized to a common network clock. Thus, the audio source device 110 can broadcast the command packet for receipt by each of the speaker devices 120a-f, and then sequentially transmit a different packet of audio data to each of the speaker devices 120a-f before the synchronized start time occurs. The broadcast command packet may include, for example, a defined logical transport address (LT-ADDR) value (e.g., an all-zero LT-ADDR) which triggers the speaker devices 120a-f to pick-up and respond thereto.

Alternatively, the audio source device 110 can transmit a different packet of audio data to each of the speaker devices 120a-f, for temporary buffering in the audio data buffer 512, and then transmit a broadcast command packet that instructs each of the speaker devices 120a-f when (e.g., immediately) to begin decoding and generating sound from the buffered audio data and/or when to begin outputting decoded PCM data to the speaker 530.

The payload of the broadcast packet may indicate a relative time that the speaker devices 120a-f should await before decoding the associated audio data and/or before outputting decoded PCM data to the speaker 530. For example, the broadcast packet can specify a delay time after occurrence of the broadcast packet (e.g., after occurrence of an access code or other signaling associated with the broadcast packet) that the speaker devices 120a-f should await before decoding the associated audio data and/or before outputting decoded PCM data to the speaker 530. The delay time may be defined in, for example, microseconds relative to the internal clock and/or relative to a number of slots or frames such that the frame boundaries of the Bluetooth piconet serve as the referenced timing event to trigger decoding.

Alternatively, the payload of the broadcast packet may indicate an absolute time relative to the internal clock and/or an absolute frame number that the speaker devices 120a-f should await before decoding the associated audio data and/or before outputting decoded PCM data to the speaker 530.

Alternatively, the audio source device 110 can sequentially transmit a separate control packet to each of the speaker devices 120a-f that specifies a relative time or absolute time at which the corresponding one of speaker devices 120a-f should await before decoding the associated audio data and/or before outputting decoded PCM data to the speaker 530. Accordingly, the closer that the control packet is sent to the start time, the smaller the delay that is indicated by the payload of the control packet. Accordingly, each of the speaker devices 120a-f may be command to begin audio decoding at the same or different times via the separate control packets that are transmitted thereto.

In some other embodiments, instead of adjusting the local clock signal 402, which is used as a local system clock during transmitting/receiving data, the speaker device may generate adjusted clock signals for controlling audio decoding and/or frequency hopping by adjusting a Low Power Oscillator (LPO) clock that is used to maintain periodic synchronization of the Bluetooth radio 500 in each of speaker devices with the Bluetooth piconet when operating in a power-savings Bluetooth Sniff mode. The LPO clock can be configured to provide timing for events used in power-savings mode like the Bluetooth sniff node. Because this clock is also compensated for drift relative to the common network clock, it can also be used as stable common reference clock across the slave devices and the audio source device 110. During active mode (when streaming audio data is being received and sound generated therefrom), the LPO clock can be synchronized to the local clock device 400 to increase its short-term stability.

Although various separate functional blocks have been shown in FIG. 5 for purposes of illustration and discussion, it is to be understood that at least some of their functionality described herein may be integrated within a common integrated circuit package or distributed among more than one integrated circuit package.

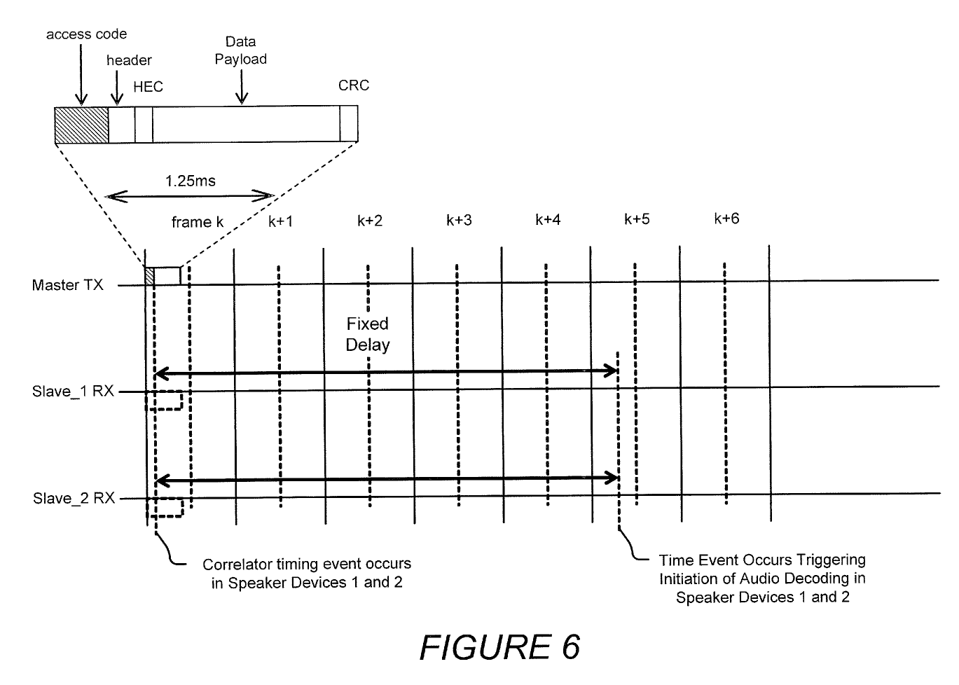

FIG. 6 is a timing diagram that illustrates exemplary operations and methods that can be carried out by each of a plurality of Bluetooth speaker devices to synchronize the initiation of audio decoding and to compensate for timing skew in response to occurrence of defined timing events in the Bluetooth piconet.

Referring to FIG. 6, a command packet is broadcast in frame k. In frame k+2, a first packet of audio data is transmitted from the audio source device 110 to a speaker device (e.g., to speaker 120a of FIG. 1 with left front component audio data). Subsequently, in frame k+3 a second packet of audio data is transmitted from the audio source device 110 to another speaker device (e.g., to speaker 120b of FIG. 1 with left rear component audio data). In frame k+3 a third packet of audio data is transmitted to another speaker (e.g., to speaker 120c of FIG. 1 with right front component audio data), and then in frame k+4 a fourth packet of audio data is transmitted to another speaker (e.g., to speaker 120d of FIG. 1 with right rear component audio data). The command instructs the speaker devices 120a-d to simultaneously initiate decoding of the previously received packets of audio data after a defined number of cycles of their respective adjusted audio clock signals 540 during frame k+5, which corresponds to 5 frames after the frame k when the command packet was transmitted thereto.

The audio decoders 510 in the speaker devices 120a-d are clocked with the adjusted audio clock signal 540 which are repetitively adjusted by the offset 406 in response to defined signaling of frames of the Bluetooth piconet. As described above and illustrated in FIG. 6, the defined signaling of the Bluetooth piconet that triggers adjustment of the value of the offset 406 may correspond to the frame access code, the header start, the HEC of the packet header, and/or the CRC of the packet payload. The event detector 506 can output the audio start signal 542 to trigger the decoder circuit 514 to begin decoding the buffered audio data and generating sound therefrom and/or to trigger the PCM data buffer 516 to begin clocking the PCM data through the DAC 520 to the speaker 530 responsive to cycles of the adjusted audio clock signal 540. The decoding operation of the audio decoders and/or the output of the PCM data from the buffer 516 are therefore controlled so as to remain time aligned because the Bluetooth piconet signaling is used as a common master clock for all audio processing.

The audio source device 110 may or may not include a speaker. When the audio source device 110 includes a speaker through which a component of music is played in concert with the speaker devices, the audio source device 110 should also adjust its pulse code modulated (PCM) internal clock relative to the common network clock that is used by the speaker devices.

In some other embodiments of the audio distribution system, the speaker devices may include different clock circuits that generate clock signal that are separately adjusted responsive to separate offset values and which separately control operation of the transceiver (e.g., frequency hop timing) and operation of the audio decoder circuits.

Again, although various embodiments are described herein in the context of using the signaling associated with a Bluetooth piconet to function as a common master clock, the invention is not limited thereto. Instead, various embodiments of the present invention can be used in any wireless system in which signals transmitted from one unit can act as timing reference for another unit. Local clocks in speaker devices can be locked to the defined signals transmitted from a reference unit to compensate for relative drifting of their local clocks. In addition, the reference unit can send a broadcast packet to all speaker devices to instruct the speaker devices when they should simultaneously began a defined operation.

The invention is not limited to a particular audio codec format. The audio codec format that is used by the audio decoder can include, but is not limited to, Bluetooth sub-band codec (SBC), Adaptive Transform Acoustic Coding (ATRAC), Advanced Audio Coding (ACC), Dolby Digital Surround 5.1, 6.1, and/or 7.1, and/or another audio coding format.

As explained above, in some embodiments, a timing accuracy of 0.25 μs can be obtained using signaling from a Bluetooth piconet, which may be more accurate than what is needed for simple audio processing. However, other audio applications can exist which may require such timing synchronization accuracy between a plurality a speaker devices. For example, some embodiments of the present invention can be used to improve audio beam steering techniques by providing accurate synchronization of local clocks within a plurality of slave devices to provide more accurate control of phase differential output of audio signals from the slave devices. For example, the relative timing phase between corresponding sounds that are generated from each of the speaker devices may be accurately controlled to provide improved perception of spatial depth and directionality for sound, ambient noise cancellation, feedback echo cancellation, and/or to otherwise directionally steer the combined beam that formed by the speaker devices.

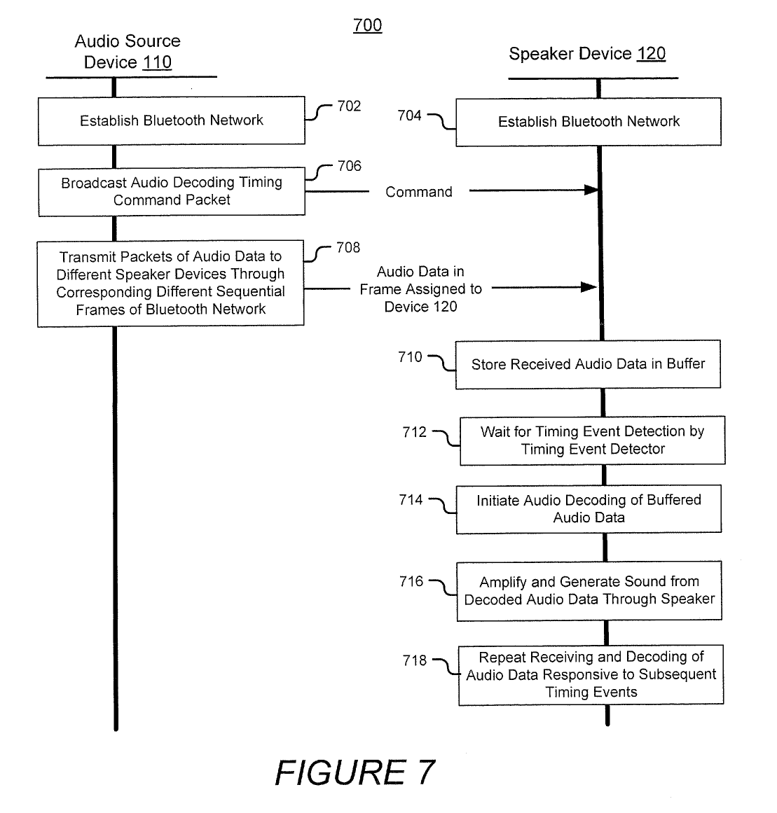

FIG. 7 is a flowchart and data flow diagram showing exemplary operations and methods of the audio source device and an exemplary one of the speaker devices, such as the speaker device of one or more of FIGS. 1-2 and 4-6, in accordance with some embodiments of the invention. Although the exemplary operations are described in the context of synchronizing the initiation of decoding, as described above, they may alternatively or additionally be used to synchronize initiation of the output of decoded PCM data to the speakers to generate sound therefrom. Referring to FIG. 7, a Bluetooth network is established between the audio source device 110 and the speaker device 120 (blocks 702 and 704). The audio source device 110 broadcast a command packet that defines a timing event that initiates audio decoding by the speaker device 120 (block 706). The audio source device 110 transmits packets of audio data to speaker device 120 and other speaker devices through corresponding different sequential frames of the Bluetooth network (block 708). The speaker device 120 stores received audio data in the buffer 512 (block 710). The speaker device 120 waits for the timing event detector 506 to detect occurrence of the defined timing event (block 712). The speaker device 120 initiates audio decoding of the buffered audio data (block 714). The decoded audio data is amplified and provided to the speaker 530 to generate sound (block 716). The audio source device 110 and the speaker device 120 repeat operations of blocks 708 through 716 to stream further packets of audio data from the audio source device 110 to the speaker device 120, and to synchronize the corresponding generation of sound from the speaker device 120 relative to other speaker devices.

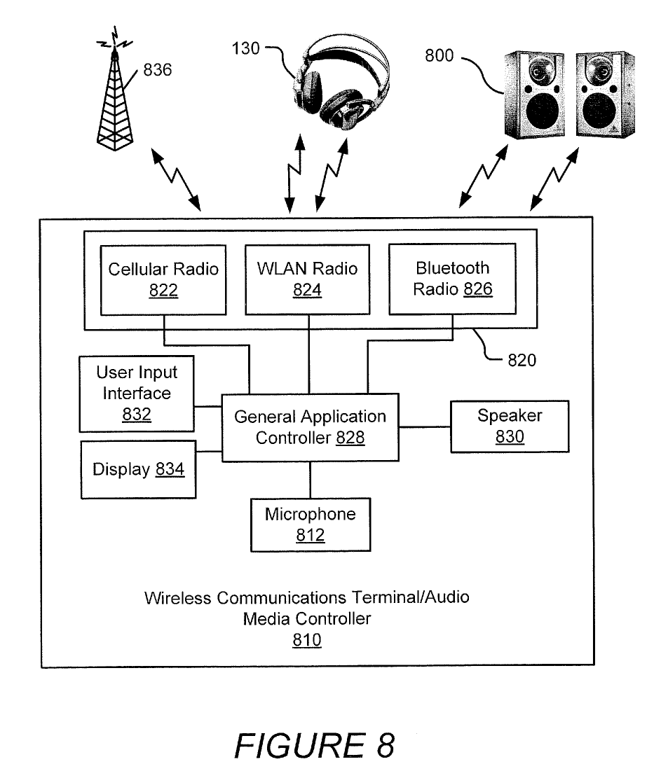

FIG. 8 is a block diagram of exemplary components of a wireless audio distribution system that includes a master wireless communication terminal/audio media controller (terminal) 810, a slave wireless headset 130, and a pair of wireless speakers 800 which are configured in accordance with some embodiments of the present invention.

Referring to FIG. 8, the wireless speakers 800 and the left and right speakers of the headset 130 may each be configured to include the circuitry shown in FIG. 5 to provide improved audio output synchronization between the speakers.

According to some embodiments, the terminal 810 includes radio circuitry 820, a microphone 812, a speaker 830, a user input interface 832 (e.g. keypad/touch interface), a display 834, and a general application controller 828 that can control operation of these and other components.

The radio circuitry 820 can include a cellular radio 822, a WLAN radio 824 (e.g., compliant with one or more of the IEEE 801.11a-g standards), and/or a Bluetooth radio 826. The cellular radio 822 can be configured to communicate using one or more cellular communication protocols such as, for example, Global Standard for Mobile (GSM) communication, General Packet Radio Service (GPRS), enhanced data rates for GSM evolution (EDGE), Integrated Digital Enhancement Network (iDEN), code division multiple access (CDMA), wideband-CDMA, CDMA2000, and/or Universal Mobile Telecommunications System (UMTS). The terminal 810 may thereby be configured to communicate through the radio circuitry 820 across a wireless air interface with a cellular transceiver base station 836 and/or another terminal, and with the headset 130 and the speakers 800.

The general application controller 828 can be configured to carry out encoding/decoding of audio data and to set up a Bluetooth communication network or other network with, for example, the headset 130, the speakers 800, and/or other slave speaker devices, and may server as a master device in the established communication network. The general application controller 828 can stream audio data through different sequential frames of a communication network, via one or more of the transceivers 822, 824, and/or 826, to a plurality of slave speaker devices, such as the speakers of the headset 130 and/or the speakers 800. The headset 130 and/or the speaker devices 800 can synchronize their internal clocks in response to timing of defined signaling from the transceivers 822, 824, and/or 826, and can initiate generation of sound therefrom in response to occurrence of a defined timing event that is responsive to defined signaling from the transceivers 822, 824, and/or 826, such as described above with regard to FIGS. 1-2 and 4-7.

Although various separate functional blocks have been shown in the figures for purposes of illustration and discussion, it is to be understood that at least some of their functionality described herein may be integrated within a common integrated circuit package or distributed among more than one integrated circuit packages.

In the drawings and specification, there have been disclosed exemplary embodiments of the invention. However, many variations and modifications can be made to these embodiments without substantially departing from the principles of the present invention. Accordingly, although specific terms are used, they are used in a generic and descriptive sense only and not for purposes of limitation, the scope of the invention being defined by the following claims.

That which is claimed:

1. A method of operating a wireless audio system, the method comprising:
establishing a wireless communication network between an audio source device and a plurality of speaker devices:
establishing a common network clock used by the audio source device and the plurality of speaker devices and which is timed relative to defined repetitively occurring signals of the wireless communication network;
receiving a command from the audio source device at each of the speaker devices via the wireless communication network that defines a timing event relative to the common network clock when each of the speaker devices is to initiate sound generation from a packet of audio data received from the audio source device; and
within each of the speaker devices, initiating sound generation from a packet of audio data previously received from the audio source device in response to occurrence of the timing event.

2. The method of claim 1, further comprising:
broadcasting the command from the audio source device for receipt by all of the speaker devices.

3. The method of claim 2, further comprising:
after broadcasting the command for receipt by all of the speaker devices, then sequentially transmitting packets of audio data to different ones of the speaker devices through corresponding different sequential communication frames of the wireless communication network configured as a time division multiple access (TDMA) network.

4. The method of claim 3, wherein the command defines a number of sequentially occurring frames that the speaker devices are to delay after the frame that transported the command before the speaker devices initiate generation of sound from their respective packets of audio data previously received from the audio source device.

5. The method of claim 1, further comprising:
transmitting the packets of audio data from the audio source device to different ones of the speaker devices through corresponding different sequential communication frames of a time divisional multiple access (TDMA) network;
generating cycles of the common network clock within the speaker devices relative to timing of receipt of defined signaling for the frames of the TDMA network; and
each of the speaker devices initiates the sound generation in response to occurrence of a timing event defined by the command relative to cycles of the common network clock.

6. The method of claim 5, wherein:
each of the speaker devices carries out audio decoding of the packet of audio data, which was previously received from the audio source device, in response to occurrence of the timing event defined by the command relative to the defined signaling for the frames of the TDMA network.

7. The method of claim 5, wherein:
the packets of audio data are transmitted from the audio source device to different ones of the speaker devices through corresponding different sequential communication frames of a Bluetooth network;
cycles of the common network clock are generated within the speaker devices relative to timing of receipt of frame access codes of the Bluetooth network;
each of the speaker devices initiates the sound generation in response to receipt of a particular one of the frame access codes that is defined by the command received from the audio source device,
wherein each of the speaker devices carries out audio decoding of the packet of audio data, which was previously received from the audio source device, in response to receipt of a frame access code that indicates occurrence of a particular frame that is defined by the command received from the audio source device.

8. The method of claim 5, wherein:
the packets of audio data are transmitted from the audio source device to different ones of the speaker devices through corresponding different sequential communication frames of a Bluetooth network;
cycles of the common network clock are generated within the speaker devices relative to timing of receipt of header start signaling, header-error correction code for data payload, and/or cyclic redundancy code for data payload within frames of the Bluetooth network; and
each of the speaker devices initiates the sound generation in response to a defined time delay after occurrence of a particular cycle of the common network clock, the defined time delay and the particular cycle being defined by the command received from the audio source device.

9. The method of claim 5, further comprising:
generating a sequence of correlation output values that each indicate an amount of correlation between a portion of a sequence of data bits received from the TDMA network and a defined pattern of data bits,
wherein each of the speaker devices initiates the sound generation in response to a determining timing of occurrence of a maximum correlation output value within a frame of the TDMA network.

10. The method of claim 1, further comprising:
within each of the speaker devices, generating an adjusted clock signal that is time offset a controllable amount relative to a local clock signal generated by a local clock circuit, wherein the time offset is controlled in response to phase differences between the local clock signal and timing of the defined repetitively occurring signals of the wireless communication network.

11. The method of claim 10, wherein the sound generation from each of the speaker devices comprises:
decoding the packed of audio data responsive to generate PCM data that is buffered in a PCM data buffer; and
initiating output of the buffered PCM data from the PCM data buffer through a digital-to-analog converter to a speaker in response to the occurrence of the timing event, and clocking the output of the PCM data from the PCM data buffer responsive to cycles of the adjusted clock signal.

12. The method of claim 10, wherein the sound generation from each of the speaker devices comprises:
operating an audio decoder to decode the packet of audio data responsive to cycles of the adjusted clock signal.

13. The method of claim 12, further comprising:
synchronizing timing of hopping through a defined sequence of frequencies at which the speaker devices communicate with the audio source device in response to cycles of the adjusted clock signal.

14. The method of claim 12, wherein:
transmitting the packets of audio data from the audio source device to different ones of the speaker devices through corresponding different sequential communication frames of a time divisional multiple access (TDMA) network;
within each of the speaker devices, the amount of time offset of the adjusted clock signal is controlled in response to timing of receipt of defined signaling for the frames of the TDMA network; and
the audio decoder within each of the speaker devices is operated responsive to cycles of the adjusted clock signal.

15. The method of claim 14, wherein:
the packets of audio data are transmitted from the audio source device to different ones of the speaker devices through corresponding different sequential communication frames of a Bluetooth network;
within each of the speaker devices, the amount of time offset of the adjusted clock signal is controlled in response to timing of receipt of frame access codes of the Bluetooth network.

16. The method of claim 14, wherein:
the packets of audio data are transmitted from the audio source device to different ones of the speaker devices through corresponding different sequential communication frames of a Bluetooth network; and
within each of the speaker devices, the amount of time offset of the adjusted clock signal is controlled in response to timing of receipt of header start signaling, header-error correction code data payload, and/or cyclic redundancy code for data payload within frames of the Bluetooth network.

17. The method of claim 14, wherein:
the packets of audio data are transmitted from the audio source device to different ones of the speaker devices through corresponding different sequential communication frames of a Bluetooth network;
the local clock circuit comprises a low power oscillator clock that is used to maintain periodic synchronization of a Bluetooth transceiver in each of speaker devices and the Bluetooth network when operating in a power-savings Bluetooth Sniff mode; and
the adjusted clock signal is time offset a controllable amount relative to the low power oscillator in response to phase differences between a signal from the low power oscillator and timing of the defined repetitively occurring signaling of frames of the Bluetooth network.

18. The method of claim 14, further comprising:
generating a sequence of correlation output values that each indicate an amount of correlation between a portion of a sequence of data bits received from the TDMA network and a defined pattern of data bits,
wherein each of the speaker devices controls the time offset of the adjusted clock signal in response to a determined timing of occurrence of a maximum correlation output value within a frame of the TDMA network.

19. A wireless speaker device comprising:
a wireless transceiver that is configured to establish a time division multiple access (TDMA) network with an audio source device, to receive from the audio source device packets of audio data in defined ones of sequentially occurring communication frames of the TDMA network, and to receive a command from the audio source device;
an audio data buffer;
a start audio decoding event detector that is configured to determine from the received command a timing event, which is defined relative to repetitively occurring signaling for the frames of the TDMA network, when the start audio decoding event detector is to generate an audio start signal to initiate audio decoding, and to generate the audio start signal in response to occurrence of the timing event;
a decoder circuit that is configured to temporarily store a received packet of audio data in the audio data buffer awaiting audio decoding, and to carry out decoding of the packet of buffered audio data in response to the audio start signal; and
a speaker circuit that is configured to generate sound in response to the decoded audio packet from the decoder circuit.

20. A wireless audio source device comprising:
a wireless transceiver that is configured to establish a time division multiple access (TDMA) network with a plurality of speaker devices; and
a controller that is configured to sequentially transmit packets of audio data to different ones of the speaker devices through corresponding different sequentially occurring communication frames of the TDMA network, and to broadcast a command to the speaker devices that defines a timing event relative to repetitively occurring signaling for the frames of the TDMA network when each of the speaker devices is to initiate audio decoding and sound generation from a packet of audio data received from the audio source device.
